(19) United States
(12) Patent Application Publication
(10) Pub. No.: US 2012/0059655 A1
(43) Pub. Date: Mar. 8, 2012

(54) METHODS AND APPARATUS FOR PROVIDING INPUT TO A SPEECH-ENABLED APPLICATION PROGRAM

(75) Inventor: John Michael Cartales, Malden, MA (US)

(73) Assignee: Nuance Communications, Inc., Burlington, MA (US)

(21) Appl. No.: 12/877,347

(22) Filed: Sep. 8, 2010

(51) Int. Cl. G10L 15/00; G10L 11/00

(52) U.S. Cl. 704/251; 704/275; 704/E15.001; 704/E11.001

(57) ABSTRACT

Some embodiments are directed to allowing a user to provide speech input intended for a speech-enabled application program into a mobile communications device, such as a smartphone, that is not connected to the computer that executes the speech-enabled application program. The mobile communications device may provide the user's speech input as audio data to a broker application executing on a server, which determines to which computer the received audio data is to be provided. When the broker application determines the computer to which the audio data is to be provided, it sends the audio data to that computer. In some embodiments, automated speech recognition may be performed on the audio data before it is provided to the computer. In such embodiments, instead of providing the audio data, the broker application may send the recognition result generated from performing automated speech recognition to the identified computer.

### BACKGROUND

1. Field of Invention

The techniques described herein are directed generally to facilitating user interaction with a speech-enabled application program.

2. Description of the Related Art

A speech-enabled software application program is a software application program capable of interacting with a user via speech input provided from the user and/or capable of providing output to a human user in the form speech. Speech-enabled applications are used in many different contexts, such as word processing applications, electronic mail applications, text messaging and web browsing applications, handheld device command and control, and many others. Such application may be exclusively speech input applications or may be multi-modal applications capable of multiple types of user interaction (e.g., visual, textual, and/or other types of interaction).

When a user communicates with a speech-enabled application by speaking, automatic speech recognition is typically used to determine the content of the user's utterance. The speech-enabled application may then determine an appropriate action to be taken based on the determined content of the user's utterance.

FIG. 1 shows conventional system including a computer 101 that executes a speech-enabled application program 105 and an automated speech recognition (ASR) engine 103. A user 107 may provide speech input to application program 105 via microphone 109, which is directly connected to computer 101 via a wired connection or a wireless connection. When a user speaks into microphone 109, the speech input is provided to ASR engine 103, which performs automated speech recognition on the speech input and provides a text recognition result to application program 105.

### SUMMARY

One embodiment is directed to a method of providing input to a speech-enabled application program executing on a computer. The method comprises: receiving, at least one server computer, audio data provided from a mobile communications device that is not connected to the computer by a wired or a wireless connection; obtaining, at the at least one server computer, a recognition result generated from performing automated speech recognition on the audio data; and sending the recognition result from the at least one server computer to the computer executing the speech-enabled application program. Another embodiment is directed to at least one non-transitory tangible computer-readable medium encoded with instructions that, when executed, perform the above-described method.

A further embodiment is directed to at least one server computer comprising: at least one tangible storage medium that stores processor-executable instructions for providing input to a speech-enabled application program executing on a computer; and at least one hardware processor that executes the processor-executable instructions to: receive, at the at least one server computer, audio data provided from a mobile communications device that is not connected to the computer by a wired or a wireless connection; obtain, at the at least one server computer, a recognition result generated from performing automated speech recognition on the audio data; and send the recognition result from the at least one server computer to the computer executing the speech-enabled application program.

### BRIEF DESCRIPTION OF DRAWINGS

In the drawings:

FIG. 1 is a block diagram of a prior art computer that executes a speech-enabled application program;

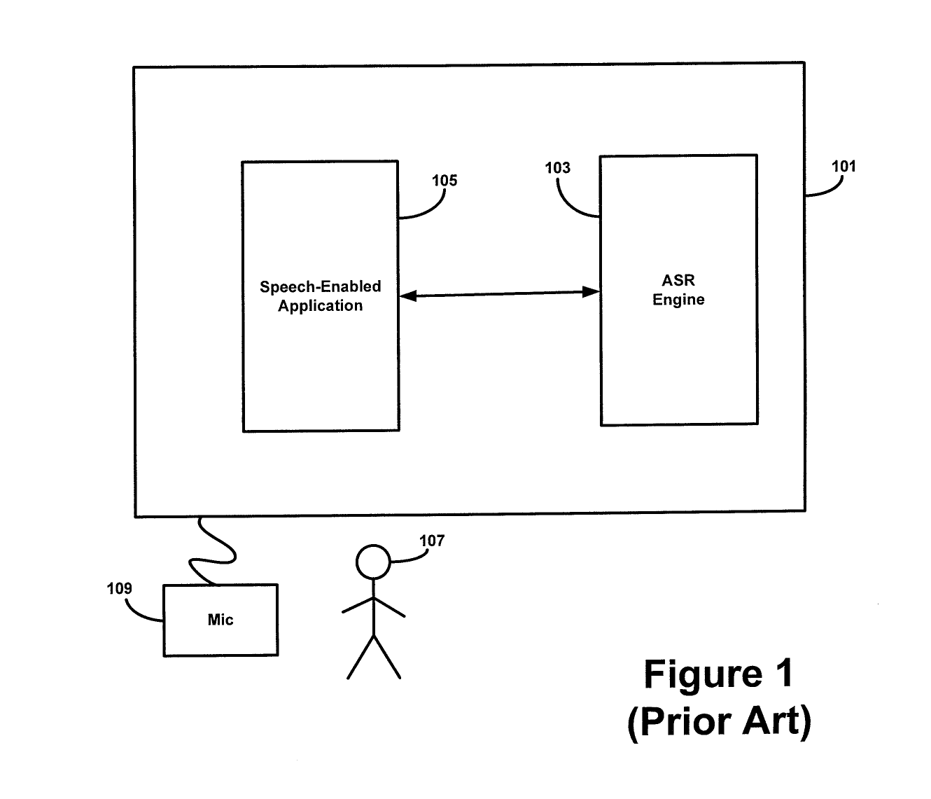

FIG. 2 is a block diagram of a computer system in which speech input intended for a speech-enabled application program executing on a computer may be provided via a mobile communications device not connected to the computer, in accordance with some embodiments;

FIG. 3 is a flow chart of process for providing input, generated from speech input, to a speech-enabled application using a mobile communications device, in accordance some embodiments;

FIG. 4 is a block diagram of a computer system in which speech input intended for a speech-enabled application program executing on a computer may be provided via a mobile communications device not connected to the computer, and in which automated speech recognition is performed on a computer different from the computer executing the speech-enabled application program, in accordance with some embodiments;

FIG. 5 is a block diagram of a computer system in which speech input intended for a speech-enabled application program executing on a computer may be provided via a mobile communications device that is connected to the computer, in accordance with some embodiments; and

FIG. 6 is a block diagram of a computing device which may be used, in some embodiments, to implement the computers and devices depicted in FIGS. 2, 4, and 5.

### DETAILED DESCRIPTION

To provide speech input to a speech-enabled application, a user typically speaks into a microphone that is connected (either by a wire or wirelessly) or built-in to the computer via which the user interacts with the speech-enabled application. The inventor has recognized that the need for the user to use such a microphone to provide speech input to the speech-enabled application may cause a number of inconveniences.

Specifically, some computers may not have a built-in microphone. Thus, the user must obtain a microphone and connect it to the computer that he or she is using to access the speech-enabled application via speech. In addition, if the computer is a shared computer, the microphone connected to it may be a microphone that is shared by many different people. Thus, the microphone may be a conduit for transmitting pathogens (e.g., viruses, bacteria, and/or other infectious agents) between people.

While some of the embodiments discussed below address all of the above-discussed inconveniences and deficiencies, not every embodiment addresses all of these inconveniences and deficiencies, and some embodiments may not address any of them. As such, it should be understood that the invention is not limited to embodiments that address all or any of the above-described inconveniences or deficiencies.

Some embodiments are directed to systems and/or methods in which a user may provide speech input for a speech-enabled application program via a mobile phone or other handheld mobile communications device, without having to use a dedicated microphone that is directly connected to the computer that the user is using to access the speech-enabled application program. This may be accomplished in any of a variety of ways, of which some non-limiting detailed examples are described below.

The inventor has recognized that because many people own personal devices (e.g., mobile phones or other handheld mobile computing devices) that typically have built-in microphones, the microphones on such devices may be used to receive a user's speech to be provided as input to a speech-enabled application program that is executing on a computer separate from these devices. In this way, the user need not locate a dedicated microphone and connect it to a computer executing the speech-enabled application or use a shared microphone connected to the computer to interact with a speech-enabled application program via voice.

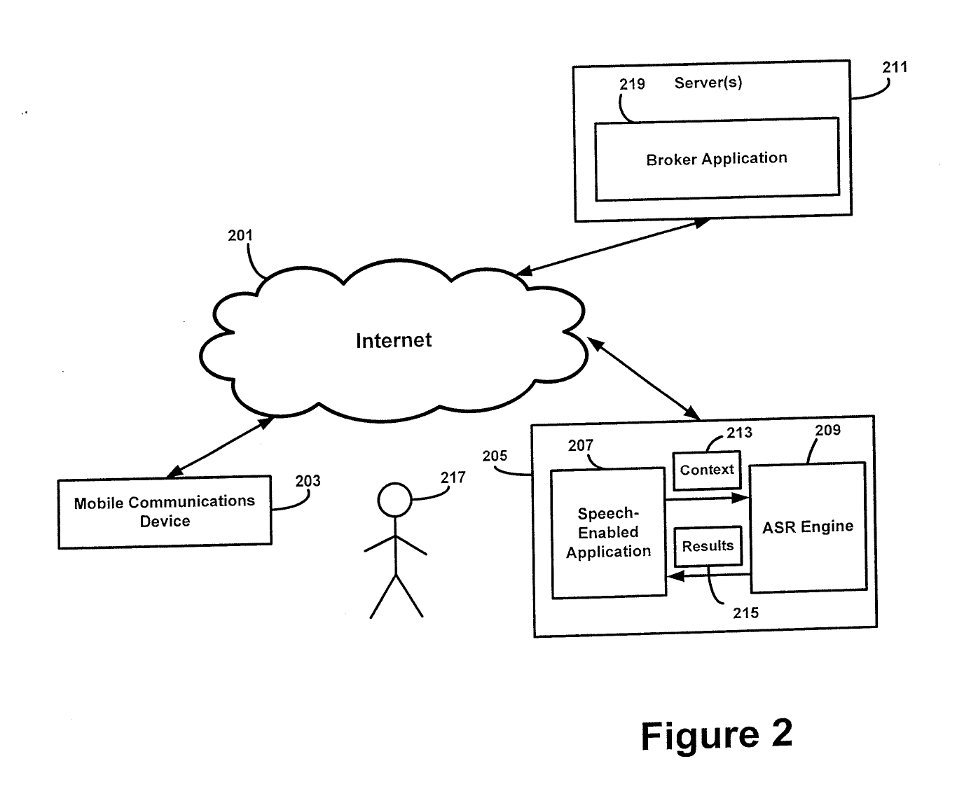

FIG. 2 shows a computer system in which a user may provide speech input to a handheld mobile communication device to interact with a speech-enabled application program that is executing on a computer separate from the handheld mobile communication device.

The computer system shown in FIG. 2 comprises a mobile communications device 203, a computer 205, and one or more server(s) 211. Computer 205 executes at least one speech-enabled application program 207 and at least one automated speech recognition (ASR) engine 209. In some embodiments, computer 205 may be a personal computer of user 217, via which user 217 may interact with one or more input/output (I/O) devices (e.g., a mouse, a keyboard, a display device, and/or any other suitable I/O device). The computer may or may not have a built-in microphone. In some embodiment computer 205, may be a personal computer that serves as the user's home computer, or may be a workstation or terminal on which the user has an account (e.g., an enterprise account), and that the user uses as an interface to access the speech-enabled application program. In other embodiments, computer 205 may be an application hosting server or virtualization server that delivers speech-enabled application 207 to a virtualization client on a personal computer (not shown) of user 217.

Mobile communications device 203 may be any of a variety of possible types of mobile communications devices including, for example, a smartphone (e.g., a cellular mobile telephone), a personal digital assistant, and/or any other suitable type of mobile communications device. In some embodiments, the mobile communications device may be a handheld and/or palm-sized device. In some embodiments, the mobile communications device may be a device capable of sending and receiving information over the Internet. Moreover, in some embodiments, the mobile communications device may be a device that has a general purpose processor capable of (and/or configured for) executing application programs and a tangible memory or other type of tangible computer readable medium capable of storing application programs to be executed by the general purpose processor. In some embodiments, the mobile communications device may include a display that may display information to its user. While mobile communications device 203, in some embodiments, includes a built-in microphone, the mobile communication device provides some additional functionality besides merely converting acoustic sound into an electrical signal and providing the electrical signal over a wired or wireless connection.

Server(s) 211 may comprise one or more server computers that execute a broker application 219. Broker application 219 may be an application that, upon receiving audio from a mobile communications device, determines to which computer or other device the received audio is to be sent, and sends the audio to that destination device. As explained in greater detail below, the audio may either be “pushed” to the destination device or “pulled” by the destination device.

It should be appreciated that, although only a single mobile communications device 203 and a single computer 205 are shown in FIG. 2, the broker application executed by server(s) 211 may serve as a broker between many (e.g, tens of thousands, hundreds of thousands, or more) mobile communications devices and computers that execute speech-enabled applications. In this respect, a broker application 219 executing on server(s) 211 may receive audio from any of a number of mobile communications devices, determine to which of a plurality of destination computers or devices that execute a speech-enabled application the received audio is to be sent, and send the audio (e.g., via Internet 201) to the appropriate destination computer or device.

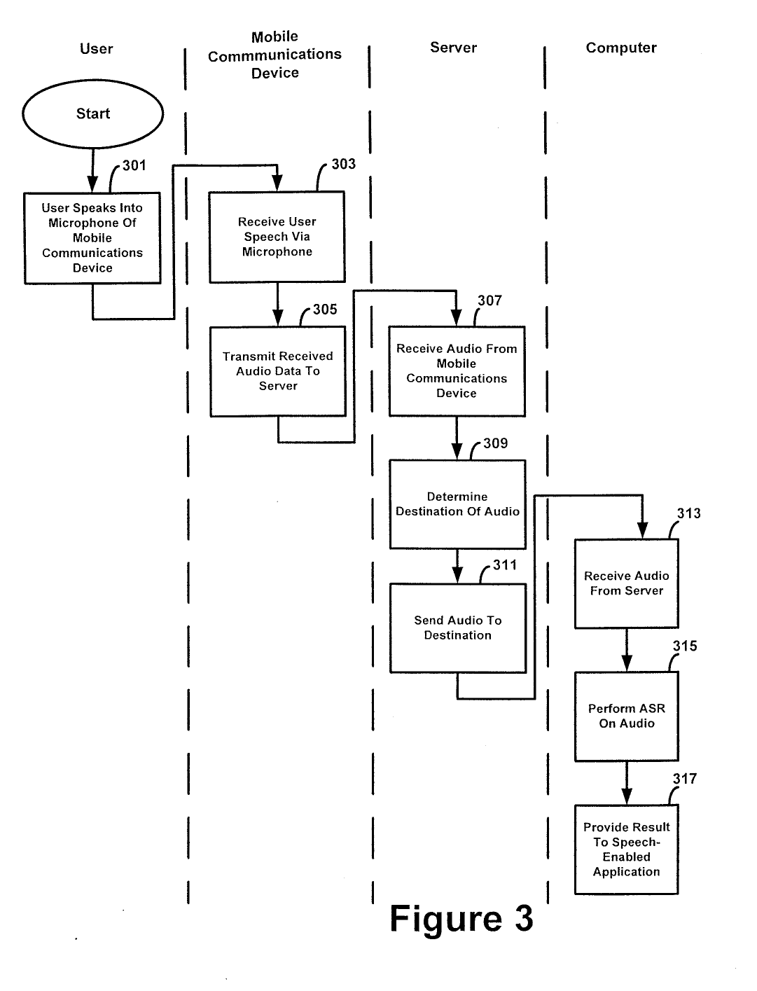

FIG. 3 is a flow chart of a process that may be used in some embodiments to enable a user to provide speech to a speech enabled application program via a mobile communications device. As can be appreciated from the discussion below, the process shown in FIG. 3 enables a user of a speech-enabled application program to speak into his or her mobile communication device and have his or speech appear as text in the speech-enabled application program in real-time or substantially real-time, even though the mobile phone is not connected, by either a wired or wireless connection, to the computer executing the speech-enabled application program or the computer via which the user accesses the speech-enabled application program (e.g., the computer with a user interface through which the user access the application).

The process of FIG. 3 begins at act 301, where a user (e.g., user 217 in FIG. 2) provides speech intended for a speech-enabled application program into a microphone of a mobile communications device (e.g., mobile communications device 203). The mobile communications device may receive speech in any suitable way, and the invention is not limited in this respect. For example, the mobile communications device may execute an application program configured to receive speech from a user and provide the speech to server(s) 211. In some embodiments, mobile communications device may receive the speech via a built-in microphone as an analog audio signal and may digitize the audio before providing it to server(s) 211. Thus, at act 301, the user may launch this application program on the mobile communications device, and speak into the microphone of the mobile communications device.

The process next continues to act 303, where the mobile communications device receives the user's speech via the microphone. Then, the process continues to act 305, where the mobile communications device transmits the received speech as audio data to a server (e.g., one of server(s) 211) that executes a broker application (e.g., broker application 219). The audio may be transmitted in any suitable format and may be compressed prior to transmission or transmitted uncompressed. In some embodiments, the audio may be streamed by the mobile communications device to the server that executes the broker application. In this way, as the user speaks into the microphone of the mobile communications device, the mobile communications device streams the audio of the user's speech to the broker application.

After transmission of the audio by the mobile communications device, the process continues to act 307, where a broker application executing on the server receives the audio transmitted from the mobile communications device. The process next continues to act 309, where the broker application determines the computer or device that is the destination of the audio data. This may be accomplished in any of a variety of possible ways, examples of which are discussed below.

For example, in some embodiments, when the mobile communications device transmits audio data to the server, it may send with the audio an identifier that identifies the user and/or the mobile communications device. Such an identifier may take any of a variety of possible forms. For example, in some embodiments, the identifier may be a username and/or password that the user inputs into the application program on the mobile communications device in order to provide audio. In alternative embodiments in which the mobile communications device is a mobile telephone, the identifier may be the phone number of the mobile telephone. In some embodiments, the identifier may be a universally unique identifier (UUID) or a guaranteed unique identifier (GUID) assigned to the mobile communications device by its manufacturer or by some other entity. Any other suitable identifier may be used.

As described in greater detail below, the broker application executing on the server may use the identifier transmitted with the audio data by the mobile communications device in determining to which computer or device the received audio data is to be sent.

In some embodiments, the mobile communications device need not send the identifier with each transmission of audio data. For example, the identifier may be used to establish a session between the mobile communications device and the server and the identifier may be associated with the session. In this way, any audio data sent as part of the session may be associated with the identifier.

The broker application may use the identifier that identifies the user and/or the mobile communications device to determine to which computer or device to send the received audio data in any suitable way, non-limiting examples of which are described herein. For example, with reference to FIG. 2, in some embodiments, computer 205 may periodically poll server(s) 211 to determine whether server(s) 211 have received any audio data from mobile communications device 203. When polling server(s) 211, computer 205 may provide to server(s) 211 the identifier associated with the audio data that was provided to server(s) 211 by mobile communications device 203, or some other identifier that the server can use to map to that identifier. Thus, when a server 211 receives the identifier from computer 205, it may identify the audio data associated with the received identifier, and determine that the audio data associated with the received identifier is to be provided to the polling computer. In this way, the audio generated from the speech of user 217 (and not audio data provided from other users' mobile communications device) is provided to the user's computer.

Computer 205 may obtain the identifier provided to server(s) 211 by the mobile communications device of user 217 (i.e., mobile communication device 203) in any of a variety of possible ways. For example, in some embodiments, speech-enabled application 207 and/or computer 205 may store a record for each user of the speech-enabled application. One field of the record may include the identifier associated with the mobile communications device of the user, which may, for example, be manually provided and input by the user (e.g., via a one-time registration process where the user registers the device with the speech-enabled application). Thus, when a user logs into computer 205, the identifier stored in the record for that user may be used when polling server(s) 211 for audio data. For example, the record for user 217 may store the identifier associated with mobile communication device 203. When user 217 is logged into computer 205, computer 205 polls server(s) 211 using the identifier from the record for user 217. In this way, server(s) 211 may determine to which computer the audio data received from mobile communications device is to be sent.

As discussed above, server(s) 211 may receive audio data provided from a large number of different users and from a large number of different devices. For each piece of audio data, server(s) 211 may determine to which destination device the audio data is to be provided by matching or mapping an identifier associated with the audio data to an identifier associated with the destination device. The audio data may be provided to the destination device associated with the identifier to which the identifier provided with the audio data is matched or mapped.

In the example described above, the broker application executing on the server determines to which computer or device the audio data received from the mobile communications device is to be sent in response to a polling request from a computer or device. In this respect, the computer or device may be viewed as “pulling” the audio data from the server. However, in some embodiments, rather than the computer or device pulling the audio data from the server, the server may “push” the audio data to the computer or device. For example, the computer or device may establish a session when the speech-enabled application is launched, when the computer is powered on, or at any other suitable time, and may provided any suitable identifier (examples of which are discussed above) to the broker application to identifier the user and/or mobile communications device that will provide audio. When the broker application receives audio data from a mobile communications device, it may identify the corresponding session, and send the audio data to the computer or device with the matching session.

After act 309, the process of FIG. 3 continues to act 311, where the broker application on the server sends the audio data to the computer or device determined in act 309. This may be done in any suitable way. For example, the broker application may send audio data to the computer or device over the Internet, via a corporate Intranet, or in any other suitable way. The process next continues to act 313, where the computer or device identified in act 309 receives the audio data sent from the broker application on the server. The process then proceeds to act 315, where an automated speech recognition (ASR) engine on or coupled to the computer or device performs automated speech recognition on the received audio data to generate a recognition result. The process next continues to act 317, where the recognition result is passed from the ASR engine to the speech-enabled application executing on the computer.

The speech-enabled application may communicate with the ASR engine on or coupled to the computer to receive recognition results in any suitable manner, as aspects of the invention are not limited in this respect. For example, in some embodiments, the speech-enabled application and the ASR engine may use a speech application programming interface (API) to communicate.

In some embodiments, the speech-enabled application may provide context to the ASR engine that may assist the ASR engine in performing speech recognition. For example, as shown in FIG. 2, speech-enabled application 207 may provide context 213 to ASR engine 209. ASR engine 209 may use the context to generate result 215 and may provide result 215 to the speech-enabled application. The context provided from a speech-enabled application may be any information that is usable by the ASR engine 209 to assist in automated speech recognition of audio data directed towards the speech-enabled application. For example, in some embodiments, the audio data directed towards the speech-enabled application may be words intended to be placed in a particular field in a form provided or displayed by the speech-enabled application. For example, the audio data may be speech intended to fill in an “Address” field in such a form. The speech-enabled application may supply, to the ASR engine, the field name (e.g., “Address”) or other information about the field as context information, and the ASR engine may use this context to assist in speech recognition in any suitable manner.

In the illustrative embodiments described above, the ASR engine and the speech-enabled application execute on the same computer. However, the invention is not limited in this respect, as in some embodiments, the ASR engine and the speech-enabled application may execute on different computers. For example, in some embodiments, the ASR engine may execute on another server separate from the server that executes the broker application. For example, an enterprise may have one or more dedicated ASR servers and the broker application may communication with such a server to obtain speech recognition results on audio data.

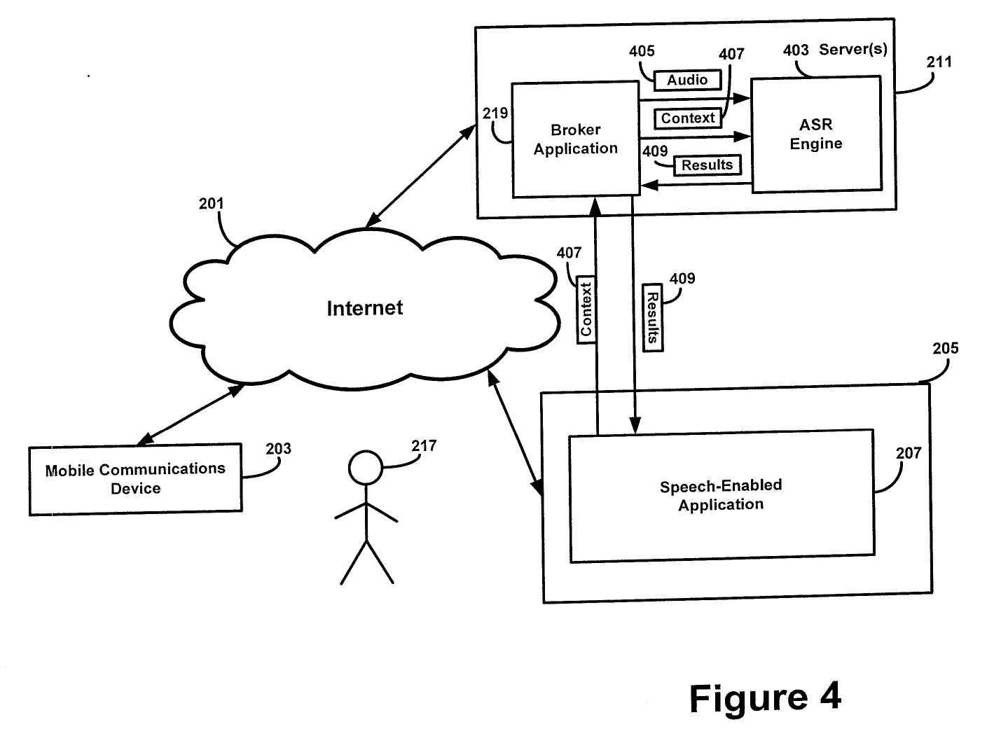

In an alternate embodiment illustrated in FIG. 4, the ASR engine may execute on the same server as the broker application. FIG. 4 shows a computer system in which a user may provide speech input to a handheld mobile communication device to interact with a speech-enabled application program that is executing on a computer separate from the handheld mobile communication device. As in FIG. 2, user 217 may provide speech intended for speech-enabled application 207 (executing on computer 205) to a microphone of mobile communications device 203. Mobile communications device 203 sends the audio of the speech to broker application 219 executing on one of server(s) 211. However, unlike the system of FIG. 2, instead of providing the received audio to computer 205, broker application 219 sends the received audio to an ASR engine 403, also executing on one of server(s) 211. In some embodiments, ASR engine 403 may operate on the same server as broker application 219. In other embodiments, ASR engine 403 may execute on a different server from broker application 219. In this respect, the broker application and the ASR functionality can be distributed among one or more computers in any suitable manner (e.g., with one or more servers dedicated exclusively to serving as the broker or the ASR engine, with one or more computers serving both functions, etc.), as the invention is not limited in this respect.

As shown in FIG. 4, broker application 219 may send the audio data (i.e., audio data 405) received from mobile communication device 203 to ASR engine 403. ASR engine may return one or more recognition results 409 to broker application 219. Broker application 219 may then transmit the recognition results 409 received from ASR engine 403 to speech-enabled application 207 on computer 205. In this way, computer 205 need not execute an ASR engine to enable speech-enabled application 207 to receive speech input provided from a user.

In an alternative embodiment, the broker application may inform the ASR engine to which destination device the recognition results are to be provided, and the ASR engine may provide the recognition results to that device, rather than sending the recognition results back to the broker application.

As discussed above, in some embodiments, speech-enabled application 207 may provide context that is used by the ASR engine to aid in speech recognition. Thus, as shown in FIG. 4, in some embodiments, speech-enabled application 207 may provide context 407 to broker application 219, and broker application 219 may provide the context to ASR engine 403 along with audio 405.

In FIG. 4, context 407 is shown being provided directly from speech-enabled application 207 on 205 to broker application 219, and result 409 is shown being provided directly from broker application 219 to speech-enabled application 207. However, it should be appreciated that these pieces of information may be communicated between the speech-enabled application and the broker application via Internet 201, via an Intranet, or via any other suitable communication medium. Similarly, in embodiments in which broker application 219 and ASR engine 403 execute on different servers, information may be exchanged between them via the Internet, intranet, or in any other suitable way.

In the examples discussed above in connection with FIGS. 2-4, mobile communications device 203 is depicted as providing audio data to server(s) 211 via data network, such as the Internet or a corporate intranet. However, the invention is not limited in this respect as, in some embodiments, to provide audio data to server(s) 211 the user may use mobile communications device 203 to dial a telephone number to place a telephone call to a service that accepts audio data and provides the audio data to server(s) 211. Thus, the user may dial the telephone number associated with the service and speak into the phone to provide the audio data. In some such embodiments, a landline-based telephone may be used to provide audio data instead of mobile communications device 203.

In the embodiments discussed above in connection with FIGS. 2-4, to provide speech input for a speech-enabled application executing on a computer, the user speaks into a mobile communications device that is not connected, by a wired or wireless connection, to the computer. However, in some embodiments, the mobile communications device may be connected via a wired or wireless connection to the computer. In such embodiments, because the audio is provided from mobile communications device 203 to computer 205 via the wired or wireless connection between these devices, a broker application is not necessary to determine to which destination device audio data is to be provided. Thus, in such embodiments, computer 205 provides audio data to a server so that ASR may be performed on the audio data, and the server provides the results of the ASR back to computer 205. The server may receive requests for ASR functionality from a variety of different computers, but need not provide the above-discussed broker functionality because the recognition results from audio data are provided back to the same device that sent the audio data to the server.

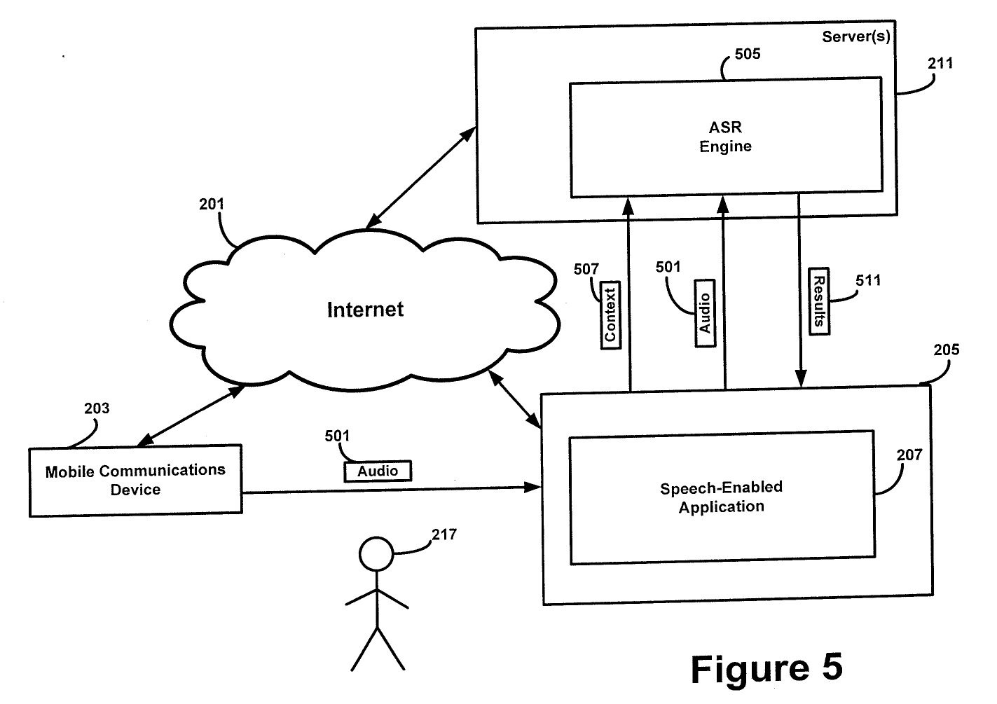

FIG. 5 is a block diagram of a system in which mobile communications device 203 is connected to computer 205 via connection 503, which may be a wired or wireless connection. Thus, user 217 may provide speech intended for speech-enabled application into a microphone of mobile communications device 203. Mobile communications device 203 may send the received speech as audio data 501 to computer 205. Computer 205 may send the audio data received from the mobile communications device to ASR engine 505 executing on server(s) 211. ASR engine 505 may perform automated speech recognition on the received audio data and send recognition result 511 to speech-enabled application 511.

In some embodiments, computer 205 may provide, with audio data 501, context 507 from speech-enabled application 207 to ASR engine 505, to aid the ASR engine in performing speech recognition.

In FIG. 5, mobile communications device 203 is shown as being connected to the Internet. However, in the embodiment depicted in FIG. 5, device 203 need not be connected to the Internet, as it provided audio data directly to computer 205 via wired or wireless connection.

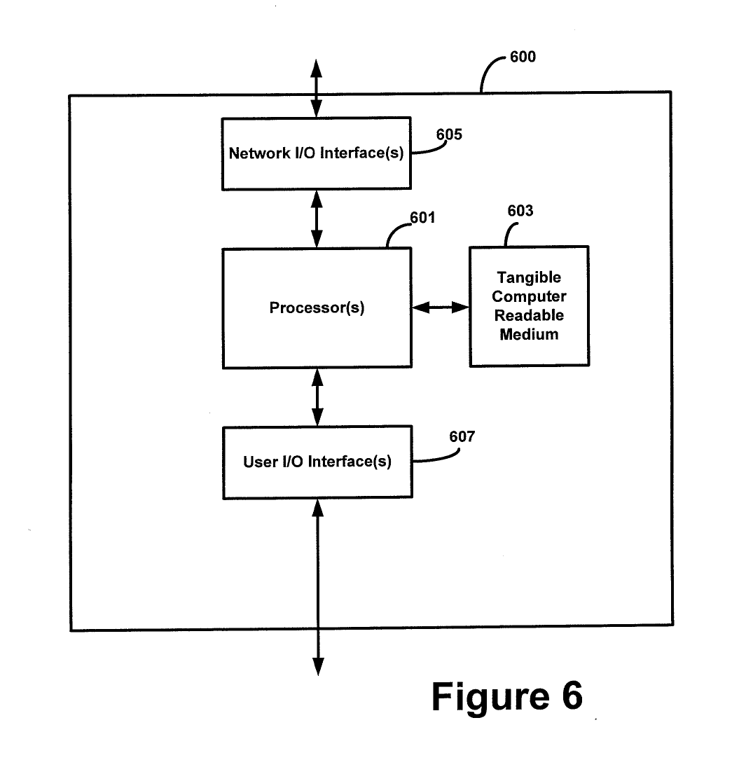

The above discussed computing devices (e.g., computers, mobile communications devices, servers, and/or any other above-discussed computing devices) each may be implemented in any suitable manner. FIG. 6 is a block diagram of an illustrative computing device 600 that may be used to implement any of the above-discussed computing devices.

The computing device 600 may include one or more processors 601 and one or more tangible, non-transitory computer-readable storage media (e.g., tangible computer-readable storage medium 603). Computer-readable storage medium 603 may store, in tangible non-transitory computer-readable storage media computer instructions that implement any of the above-described functionality. Processor(s) 601 may be coupled to memory 603 and may execute such computer instructions to cause the functionality to be realized and performed.

Computing device 600 may also include a network input/output (I/O) interface 605 via which the computing device may communicate with other computers (e.g., over a network), and, depending on the type of computing device, may also include one or more user I/O interfaces, via which the computer may provide output to and receive input from a user. The user I/O interfaces may include devices such as a keyboard, a mouse, a microphone, a display device (e.g., a monitor or touch screen), speakers, a camera, and/or various other types of I/O devices.

As should be appreciated from the discussion above in connection with FIGS. 2-4, the systems and methods described above permit a user to launch a speech-enabled application program on his or her computer, provide audio into a mobile communications device not connected to the computer via a wired or wireless connection, and view recognition results obtained from the audio data on the computer in real-time or substantially real-time. As used herein, viewing the results in real-time means that the recognition result for audio data appears on the user's computer less than a minute after the user provided the audio data and, more preferably, less than ten seconds after the user provided the audio data.

In addition, using the systems and methods described above in connection with FIGS. 2-4, a mobile communications device receives audio data from a user (e.g., via a built-in microphone) and sends the audio data to a server and, after the server acknowledges receipt of the audio data, does not expect any response from the server. That is, because the audio data and/or recognition results are provided to a destination device that is separate from the mobile communications device, the mobile communications device does not await or expect to receive any recognition result or response from the server that is based on the content of the audio data.

As should be appreciated from the discussion above, the broker application(s) on server(s) 211 may provide a broker service for many users and many destination devices. In this respect, server(s) 211 may be thought of as providing a broker service “in the cloud.” The servers in the cloud may receive audio data from a large number of different users, determine the destination devices to which the audio data and/or results obtained from the audio data (e.g., by performing ASR on the audio data) are to be sent, and send the audio data and/or results to the appropriate destination devices. Alternatively, server(s) 211 may be servers operated in the enterprise and may provide the broker service to users in the enterprise.

It should be appreciated from the discussion above, that the broker application executing on one of server(s) 211 may receive audio data from one device (e.g., a mobile communications device) and provide the audio data and/or results obtained from the audio data (e.g., by performing ASR on the audio data) to a different device (e.g., a computer executing or providing a user interface by which a user can access a speech-enabled application program). The device from which the broker application receives audio data and the device to which the broker application provides audio data and/or results need not be owned or managed by the same entity that owns or operates the server that executes the broker application. For example, the owner of the mobile device may be an employee of the entity that owns or operates the server, or may be a customer of such an entity.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of various embodiments of the present invention comprises at least one tangible, non-transitory computer-readable storage medium (e.g., a computer memory, a floppy disk, a compact disk, and optical disk, a magnetic tape, a flash memory, circuit configurations in Field Programmable Gate Arrays or other semiconductor devices, etc.) encoded with one or more computer programs (i.e., a plurality of instructions) that, when executed on one or more computers or other processors, performs the above-discussed functions of various embodiments of the present invention. The computer-readable storage medium can be transportable such that the program(s) stored thereon can be loaded onto any computer resource to implement various aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of providing input to a speech-enabled application program executing on a computer, the method comprising:
receiving, at least one server computer, audio data provided from a mobile communications device that is not connected to the computer by a wired or a wireless connection;
obtaining, at the at least one server computer, a recognition result generated from performing automated speech recognition on the audio data; and
sending the recognition result from the at least one server computer to the computer executing the speech-enabled application program.

2. The method of claim 1, wherein the mobile communications device comprises a smartphone.

3. The method of claim 1, wherein the at least one server is at least one first server, and wherein the act of obtaining the recognition result further comprises:
sending the audio data to an automated speech recognition (ASR) engine executing on at least one second server; and
receiving the recognition result from the at least one (ASR) engine on the at least one second server.

4. The method of claim 1, wherein the act of obtaining the recognition result further comprises:
generating the recognition result using at least one automated speech recognition (ASR) engine executed on the at least one server.

5. The method of claim 1, wherein the computer is a first computer of a plurality of computers, and wherein the method further comprises:
receiving, from the mobile communications device, an identifier associated with the audio data; and
using the identifier to determine that the first computer is the one of the plurality of computers to which the recognition result is to be sent.

6. The method of claim 5, wherein the identifier is a first identifier, and wherein the act of using the first identifier to determine that the first computer is the one of the plurality of computers to which the recognition result is to be sent further comprises:
receiving a request from the first computer for audio data, the request including a second identifier;
determining whether the first identifier matches or maps to the second identifier; and
when it is determined that the first identifier matches or maps to the second identifier, determining that the first computer is the one of the plurality of computers to which the recognition result is to be sent.

7. The method of claim 6, wherein the act of sending the recognition result from the at least one server computer to the computer executing the speech-enabled application program is performed in response to determining that the first computer is the one of the plurality of computers to which the recognition result is to be sent.

8. At least one non-transitory tangible computer-readable medium encoded with instructions that, when executed by at least one processor of at least one server computer, perform a method of providing input to a speech-enabled application program executing on a computer, the method comprising:
receiving, at the at least one server computer, audio data provided from a mobile communications device that is not connected to the computer by a wired or a wireless connection;
obtaining, at the at least one server computer, a recognition result generated from performing automated speech recognition on the audio data; and
sending the recognition result from the at least one server computer to the computer executing the speech-enabled application program.

9. The at least one non-transitory tangible computer-readable medium of claim 8, wherein the mobile communications device comprises a smartphone.

10. The at least one non-transitory tangible computer-readable medium of claim 8, wherein the at least one server is at least one first server, and wherein the act of obtaining the recognition result further comprises:
sending the audio data to an automated speech recognition (ASR) engine executing on at least one second server; and
receiving the recognition result from the at least one (ASR) engine on the at least one second server.

11. The at least one non-transitory tangible computer-readable medium of claim 8, wherein the act of obtaining the recognition result further comprises:
generating the recognition result using at least one automated speech recognition (ASR) engine executed on the at least one server.

12. The at least one non-transitory tangible computer-readable medium of claim 8, wherein the computer is a first computer of a plurality of computers, and wherein the method further comprises:
receiving, from the mobile communications device, an identifier associated with the audio data; and
using the identifier to determine that the first computer is the one of the plurality of computers to which the recognition result is to be sent.

13. The at least one non-transitory tangible computer-readable medium of claim 12, wherein the identifier is a first identifier, and wherein the act of using the first identifier to determine that the first computer is the one of the plurality of computers to which the recognition result is to be sent further comprises:
receiving a request from the first computer for audio data, the request including a second identifier;
determining whether the first identifier matches or maps to the second identifier; and
when it is determined that the first identifier matches or maps to the second identifier, determining that the first computer is the one of the plurality of computers to which the recognition result is to be sent.

14. The at least one non-transitory tangible computer-readable medium of claim 13, wherein the act of sending the recognition result from the at least one server computer to the computer executing the speech-enabled application program is performed in response to determining that the first computer is the one of the plurality of computers to which the recognition result is to be sent.

15. At least one server computer comprising:
at least one tangible storage medium that stores processor-executable instructions for providing input to a speech-enabled application program executing on a computer; and
at least one hardware processor that executes the processor-executable instructions to:
receive, at the at least one server computer, audio data provided from a mobile communications device that is not connected to the computer by a wired or a wireless connection;
obtain, at the at least one server computer, a recognition result generated from performing automated speech recognition on the audio data; and
send the recognition result from the at least one server computer to the computer executing the speech-enabled application program.

16. The at least one server computer of claim 15, wherein the at least one server is at least one first server, and wherein the at least one hardware processor executes the processor-executable instructions to obtain the recognition result by:
sending the audio data to an automated speech recognition (ASR) engine executing on at least one second server; and
receiving the recognition result from the at least one (ASR) engine on the at least one second server.

17. The at least one server computer of claim 15, wherein the at least one server is at least one first server, and wherein the at least one hardware processor executes the processor-executable instructions to obtain the recognition result by:
generating the recognition result using at least one automated speech recognition (ASR) engine executed on the at least one server.

18. The at least one server computer of claim 15, wherein the computer is a first computer of a plurality of computers, and wherein the at least one hardware processor executes the instructions to:
receive, from the mobile communications device, an identifier associated with the audio data; and
use the identifier to determine that the first computer is the one of the plurality of computers to which the recognition result is to be sent.

19. The at least one server computer of claim 18, wherein the identifier is a first identifier, and wherein at least one hardware processor uses the first identifier to determine that the first computer is the one of the plurality of computers to which the recognition result is to be sent by:
receiving a request from the first computer for audio data, the request including a second identifier;
determining whether the first identifier matches or maps to the second identifier; and
when it is determined that the first identifier matches or maps to the second identifier, determining that the first computer is the one of the plurality of computers to which the recognition result is to be sent.

20. The at least one server computer of claim 19, wherein the at least one hardware processor sends the recognition result from the at least one server computer to the computer executing the speech-enabled application program is performed in response to determining that the first computer is the one of the plurality of computers to which the recognition result is to be sent.
